(19) United States
(12) Patent Application Publication
(10) Pub. No.: US 2008/0127535 A1
(43) Pub. Date: Jun. 5, 2008

(54) All-time calendar

(76) Inventor: David Adjei, Accra (GH)

Correspondence Address: DAVID ADJEI, P.O.BOX GP18256, ACCRA, omitted

(21) Appl. No.: 11/633,141

(22) Filed: Dec. 1, 2006

(51) Int. Cl. G09D 3/04

(52) U.S. Cl. 40/118

(57) ABSTRACT

The All-Time Calendar is a 2-in-1 calendar that displays all the twelve months of a calendar year on a page, one page for normal/ordinary years and the other for leap years. It is designed in such a way that the same calendar can be used for years, the past, the present, and the future. It shows all the dates on which a particular day of the week falls in a particular year. It also shows all the 52 weeks in a year, and on what dates they begin and end. Each page is made up two separate parts—a laminated calendar and a laminated lever, which contains the days of the week arranged in an algorithm. The lever is skillfully inserted into the calendar and manipulated to set the calendar for a particular year. The lever displays seven groups of days at a time. The calendar can be designed, either in a vertical or horizontal format and also in various shapes—Wall, Table/Desk-top or Pocket-size. There is an accompanying ‘Guide for 200 Years. The calendars can be set in one of three ways, with or without the ‘Guide’.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The ALL-TIME CALENDAR belongs to the field of permanent calendars. The present calendaring system requires that new calendars are prepared/printed every year or adjusted every month. My invention uses the same calendar every year. There is a permanent calendaring system often used on computers and other electronic gadgets. There are also various versions of manually operated permanent calendars. The current permanent calendars make the days of the week fixed, and the days of a month are shifted to coincide with the days of the week—Sunday is most often the first day of the week. There is a specific space within which the months are adjusted to fit in. The All-Time Calendar makes the twelve months of a year fixed, and the days of the week are shifted to coincide with the days in the individual months. Two 12-month calendars are used, one for all ordinary/normal years, and the other for all leap years. There is an accompanying guide limited to 200 years (1901-2100) to be used to set the calendars for the past, present, and the future. The calendar can be used without the guide for a current year and also for future years. A calendar is set only once, for the whole year.

A booklet entitled, “The References Calendar, 1801-2200”, by Nana Yaw Opoku, published in 1994, helped me in the compilation of the Guide to 200 years that accompanies the calendars.

### BRIEF SUMMARY OF THE INVENTION

The All-Time Calendar is versatile and has many advantages over the present calendaring system:—
i. It is easy to use and fast to set—a whole-year calendar can be set in no time.
ii. The present permanent calendaring system as used manually and electronically, displays one month at a time, even though computers are able to print whole-year calendars for particular years.
iii. It saves space with no 30^{th} and/or 31^{st} sometimes appearing on the same line as 1^{st} on top of a month.
iv. It sets its own convention—A Sunday can be in the middle of the days of the week instead of at the beginning or at the end.
v. The calendar can be designed in horizontal or vertical formats.
vi. The same set of calendars are used for the past, the present, the future, with or without the use of an accompanying ‘Guide’.
vii. Present calendaring systems are ‘disposables’ and the present permanent calendaring system are complex to make and several manouevres and rules are needed to set them.

### BRIEF DESCRIPTION OF THE SEVERAL VIEWS OF THE DRAWING

This section lists and describes the various drawings accompanying this application.

FIG. 1. Shows the print-out of the vertical version for normal years after the design stage ready for lamination

FIG. 1A Shows the laminated calendar for normal years and the vertical version, inserted with the lever containing the days of the week, ready for trimming.

FIG. 2 Shows the print-out of the vertical version for leap years, after the design stage, ready for lamination.

FIG. 2A Shows the laminated calendar for leap year, and the vertical version, with the lever containing the days of the week, inserted, ready for trimming.

FIG. 2B Shows the flip-side of the vertical version complete.

FIG. 3. Shows the print-out of the normal years calendar, horizontal version, after the design, ready for lamination.

FIG. 3A Shows the laminated calendar for normal years, and the horizontal version, with the lever containing the days of the week inserted ready for trimming.

FIG. 4 Shows the print-out of the leap years, horizontal version, ready for lamination.

FIG. 4A Shows the laminated, horizontal version for leap years, with the lever inserted.

FIG. 4B Shows the flip-side of the horizontal versions.

FIG. 5 Shows the various stages of designing, cutting out the design, laminating the individually cut out design, and trimming out the levers from the lamination for the horizontal versions.

FIG. 5A Shows the various stages of designing, cutting out the design, laminating the individually cut out design, and trimming out the levers from the lamination for the vertical versions.

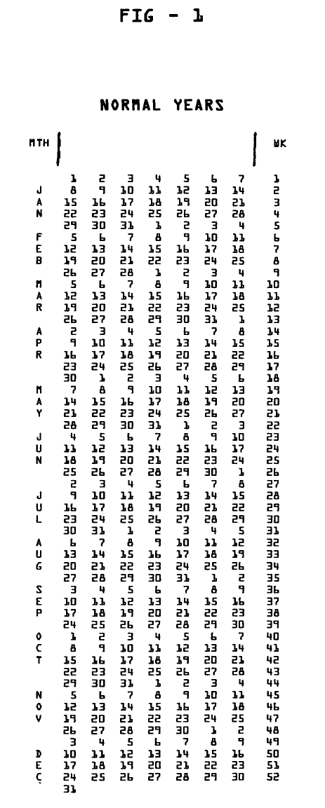

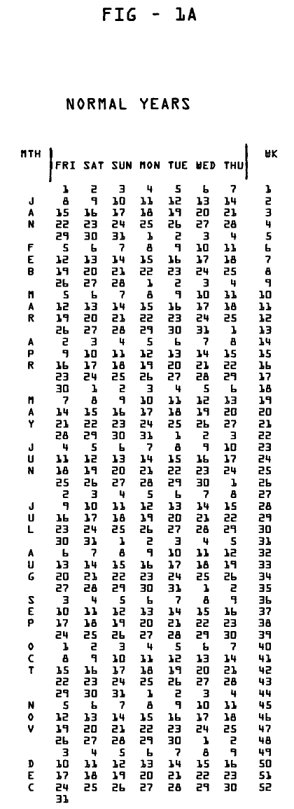

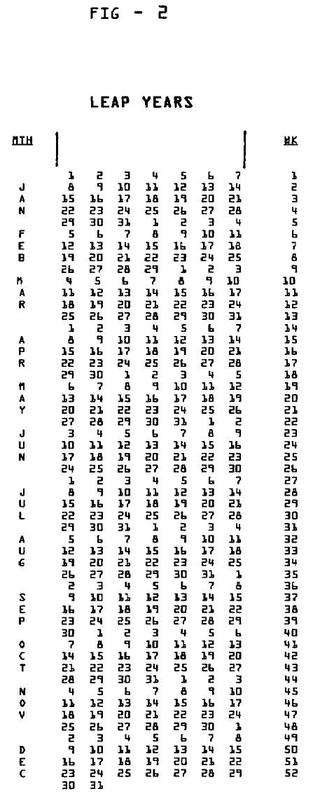

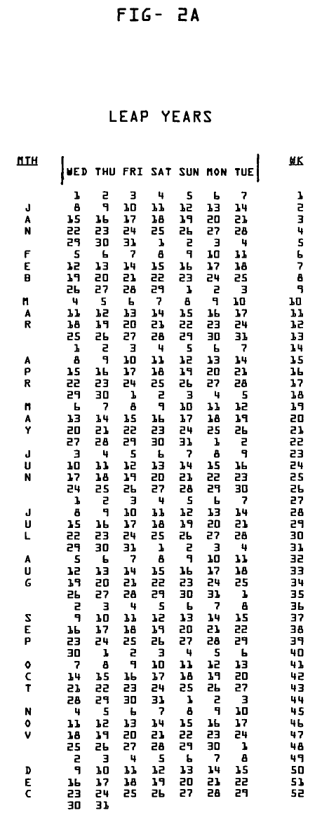

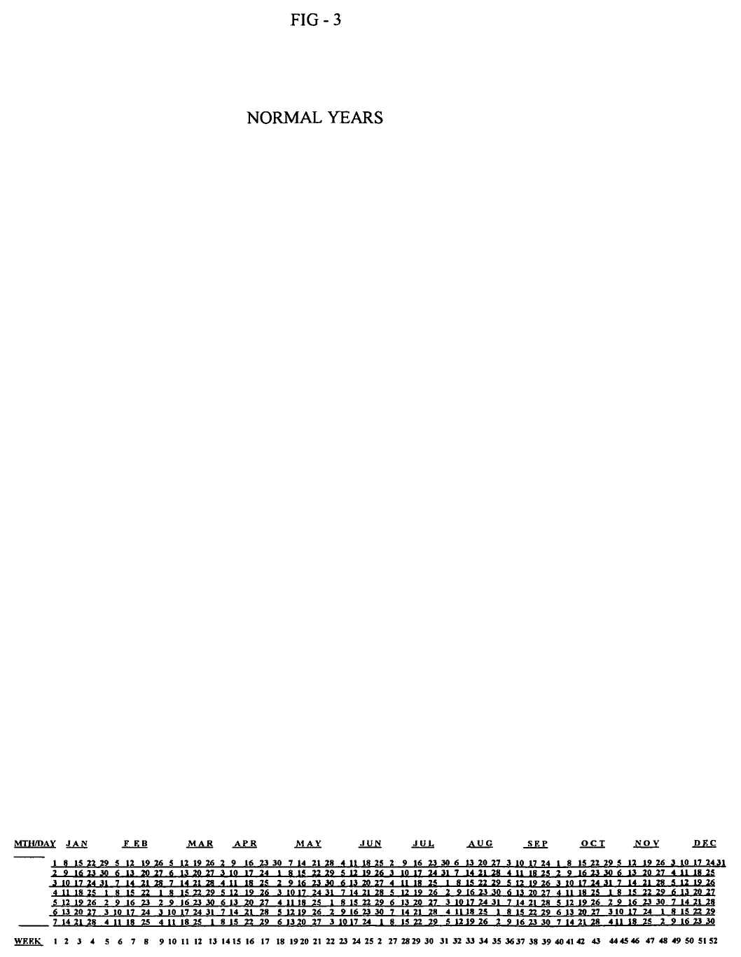

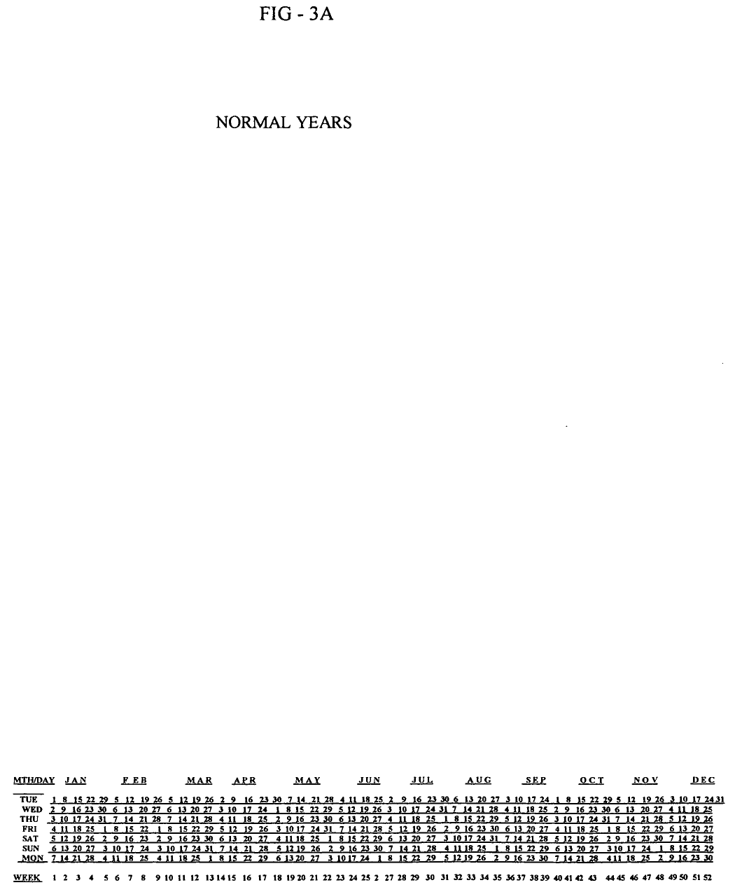

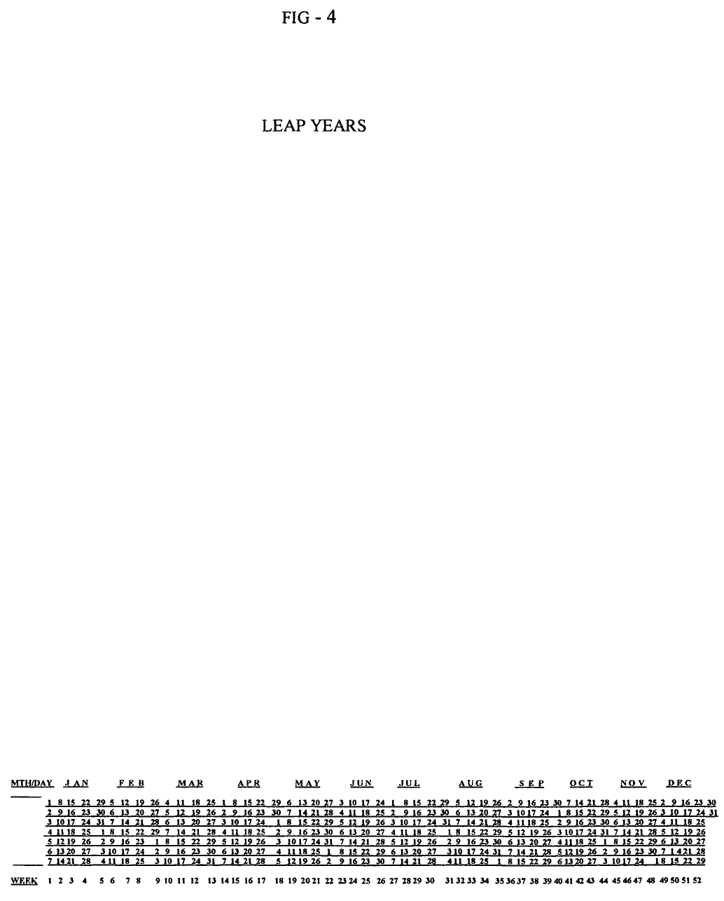

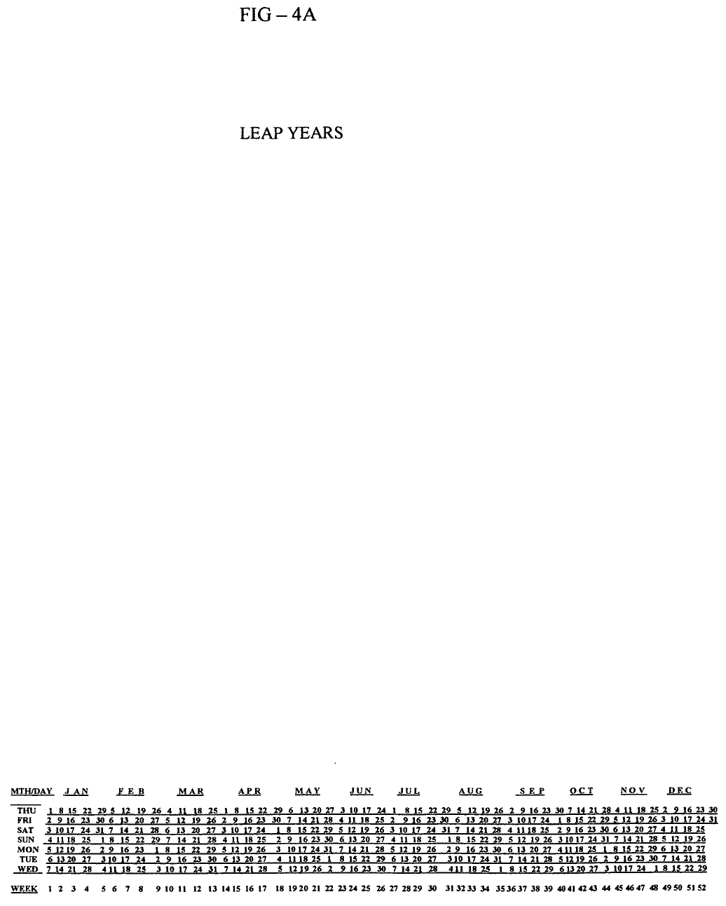

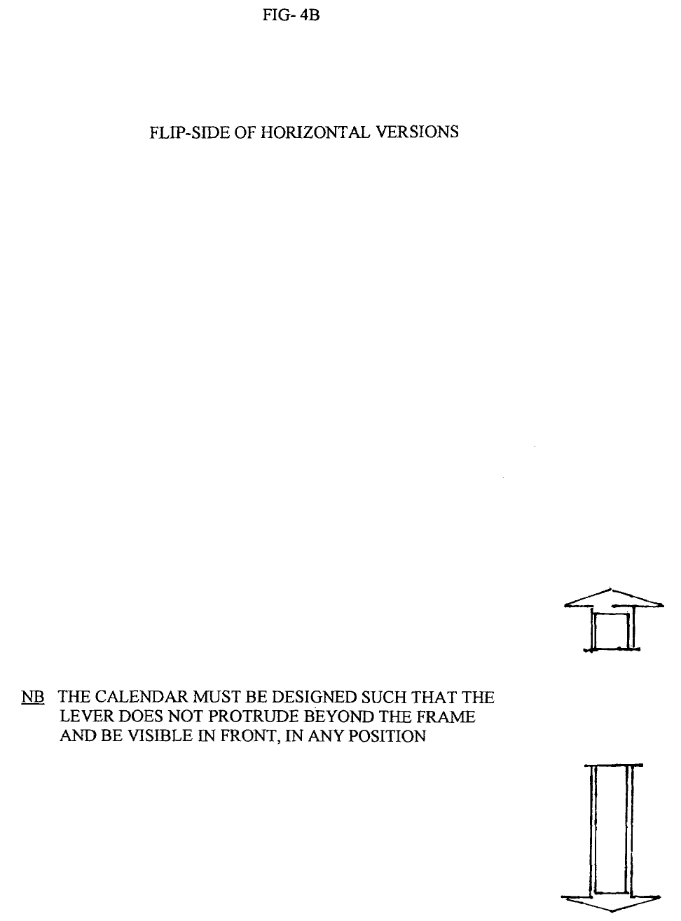

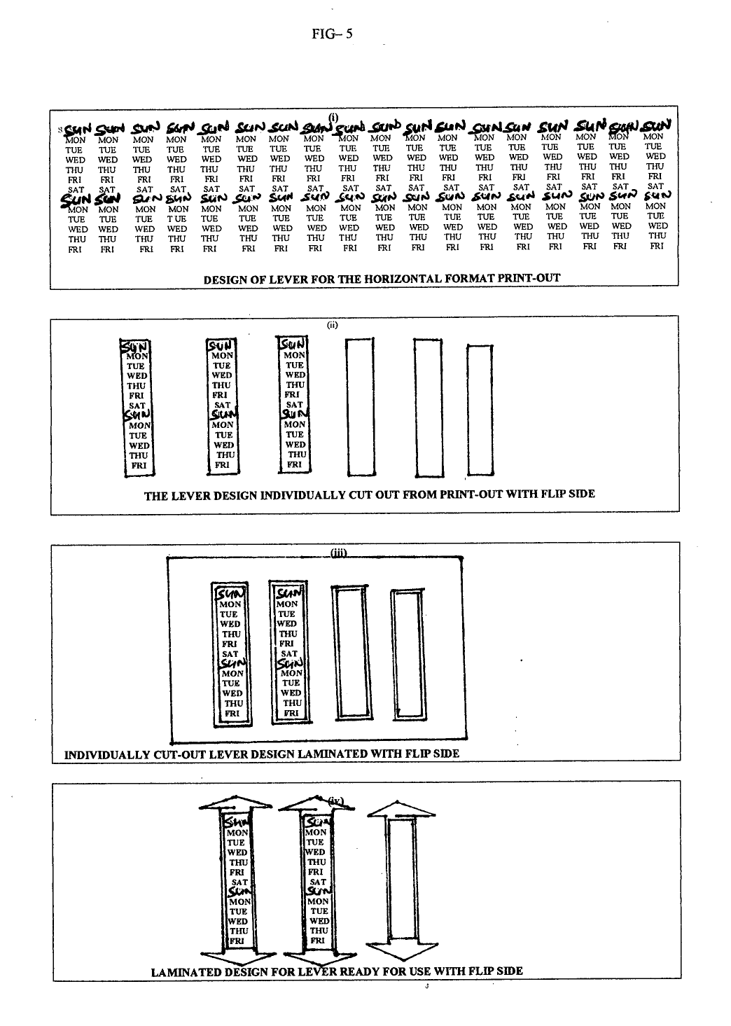

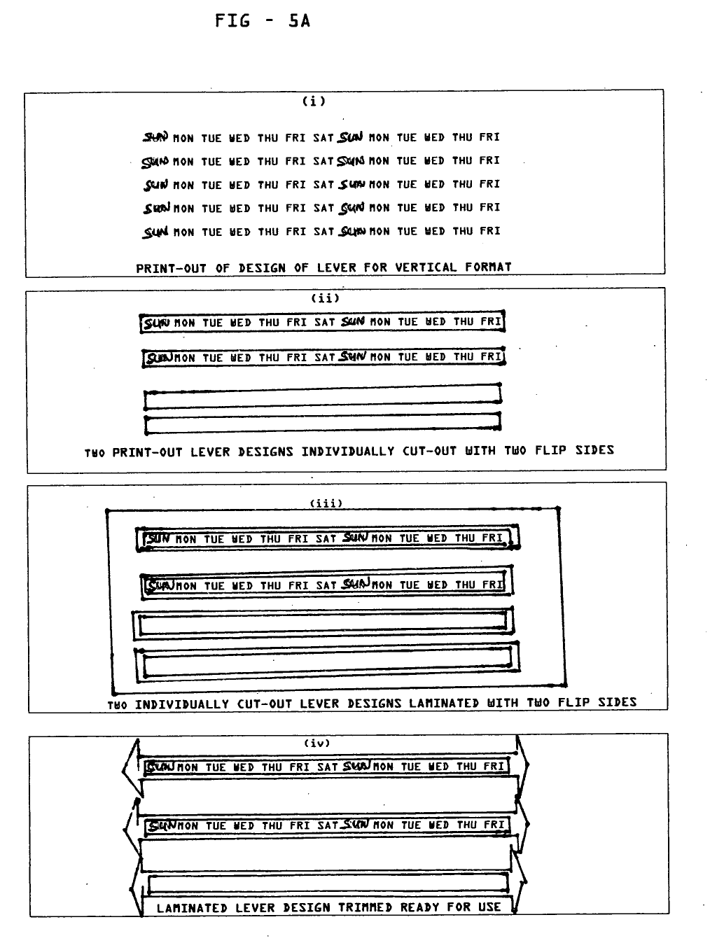

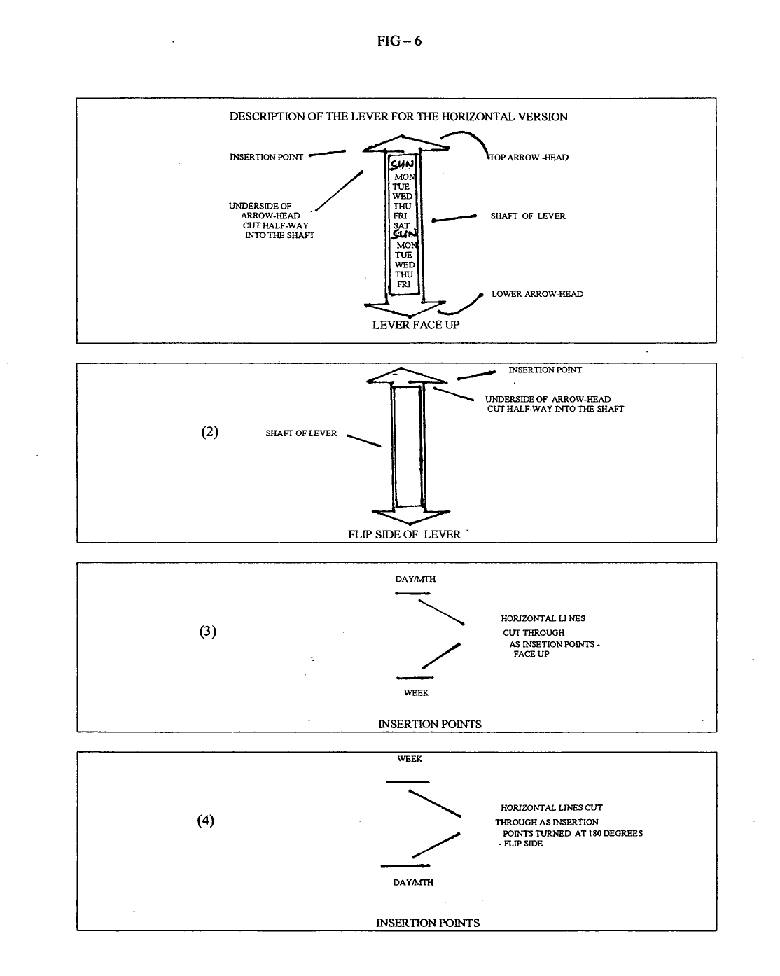

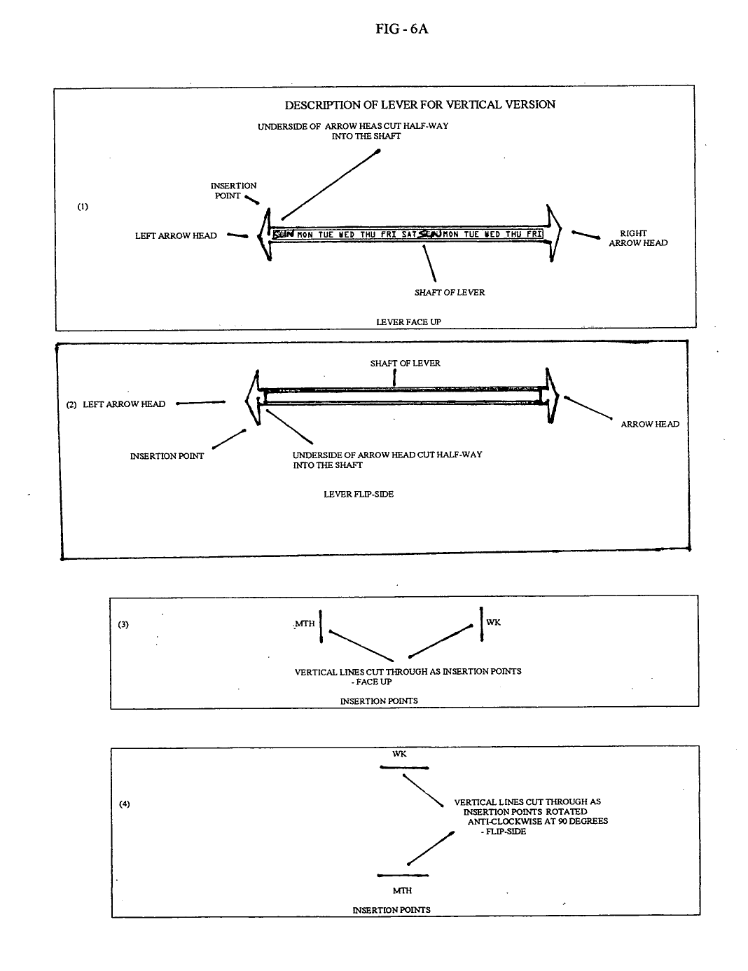

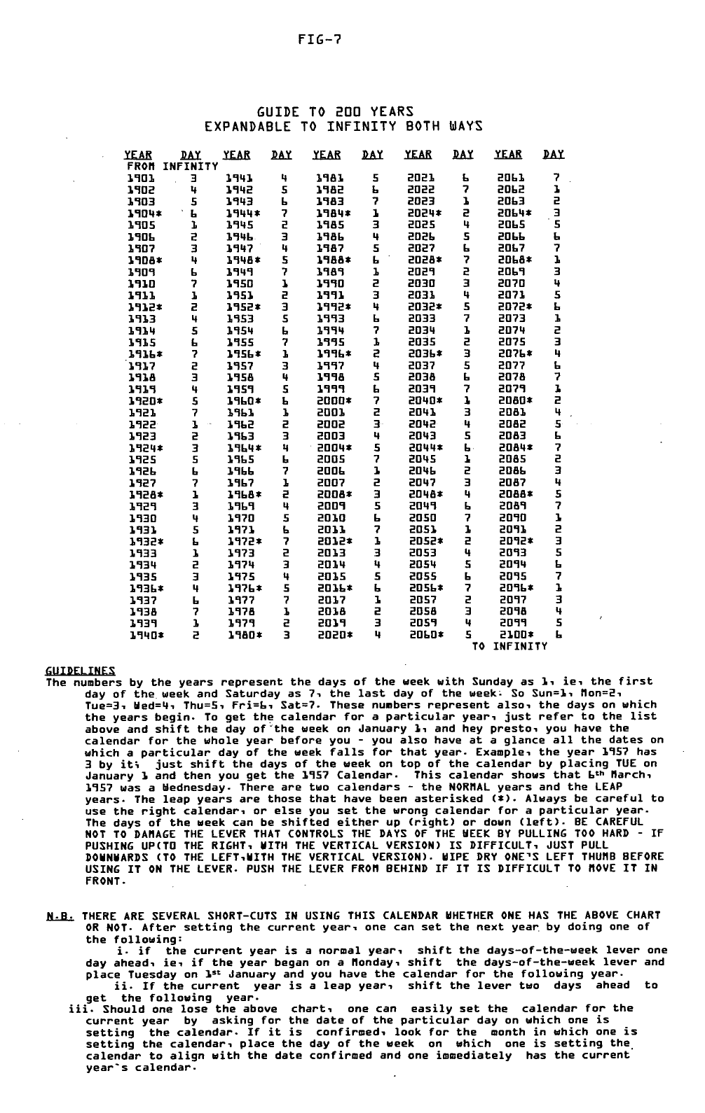

FIG. 6 Shows a description of the various stages of inserting the lever into the horizontal versions of the calendars as explained below:—
i.-iv Describes the lever viewed from various angles and the insertion points on the calendars (both for normal and leap years) also viewed from various angles.
ii. Refer to FIG. 6.i—Pick the lever with the face up and Sun up and Fri down.
iii. Refer to FIG. 6.iv—Pick the horizontal calendar; turn to the flip-side.
iv. Refer to (ii) and (iii) above and do as stated. Insert the left arrow-head into the calendar with the insertion tip of the arrow head through the insertion point at WEEK. Press the arrow head till it is half-way into the shaft of the lever. Whilst in this position, rotate the lever anti-clockwise (raise the lever upwards) till the other tip of the top arrow head passes through the insertion point, WEEK. Turn the calendar face up and pull the lever through the calendar. Bend the shaft till one is able to insert the top arrow head into the insertion point marked DAY/MTH on the face of the calendar, using the same technique as in the insertion point at WEEK above. With the lever inserted into the calendar, one should be able to manipulate the lever with the thumb from the face of the calendar.

FIG. 6A. Describes the lever for the vertical versions viewed from various angles and the insertion points as applied to both the normal and leap years:—
i. Refer to FIG. 6A.i. Pick the lever with the flip-side facing you, and Sun on the left, and Fri on the right.
ii. Pick the vertical calendar; turn to the flip-side and rotate the calendar anti-clockwise at 90 degrees; the insertion points will turn horizontal instead of vertical, with MTH on top, and WK down (as shown on the face of the calendar).
   Refer to (i) and (ii) above and do as stated. Insert the left arrow head into the calendar with the insertion tip of the arrow head through the insertion point at MTH. Press the arrowhead till it is half-way into the shaft of the lever; whilst in this position, rotate the lever anti-clockwise (raise the lever upwards) till the other tip of the arrow head passes through the insertion point marked MTH. Turn the calendar face up and pull the lever through the calendar. Bend the lever till one is able to insert the left arrow head into the insertion point WK on the face of the calendar using the same technique as in the insertion point at MTH above. With the lever inserted into the calendar, one should be able to manipulate the lever with the thumb from the face of the calendar.

FIG. 7 Shows a ‘Guide to 200 years, 1901-2100’ expandable to infinity, both backwards and forwards.

### DETAILED DESCRIPTION OF THE INVENTION

The All-time Calendar is first designed, using either the horizontal or vertical versions. It is a 2-in-1 calendar that displays all the twelve months of a calendar year on a page, one page for normal/ordinary years and the other for all leap years. It is designed in such a way that the same calendar can be used for years—the past, the present, and the future. It shows all the dates on which a particular day of the week falls in a particular year. It shows all the 52 weeks in a year and on what dates they begin and end.

Each page is made up of two parts—a laminated calendar and a laminated lever which contains the days of the week arranged in an algorithm. The lever is skillfully inserted into the laminated calendar and manipulated to set the calendar for a particular year. The lever displays seven groups of days at a time. The following steps are followed:—
i. The two calendars are first designed using either the horizontal or vertical versions. The months follow each other closely and must necessarily have different colours to differentiate them from each month.
ii. The horizontal version is designed with 7 (seven) rows representing the days of the week and 52 (fifty-two) columns representing the 52 weeks in the year and starting from the left with January followed by February through to December, to the right; with the rows numbered 1-7 vertically, 8-15, with the months following each other immediately to the last month, December. This applies to both the normal and leap years.
iii. The vertical version is designed with 7 (seven) columns, representing the days of the week, starting from the left to right, with 1-7, as 1^{st} week, followed by 8-15, as 2^{nd} week downwards, with each month following one another consecutively, to December. There are 52 rows numbered vertically to represent the 52 weeks in a year. This applies to both the normal and leap years.
iv. The days-of-the-week lever is also designed ensuring that the font, font size, and line spacing are the same as that of the two calendars so as to align with the days in the two calendars. Sundays are printed in the colour, ‘Red’.

### The designed calendars are printed and trimmed to suit a particular size of a laminating pouch.

viii. The calendars are laminated and trimmed.
ix. There are two lines on each calendar on the left side (or on top) of the month of January which are cut, with an appropriate tool, to allow the days-of-the-week lever to be skillfully inserted.
x. For best display after lamination, photographic paper should be used as the medium for the print-out.
xi. After printing out the days-of-the-week design, the designs must be cut out individually and carefully placed in a laminating pouch for lamination.
xii. The laminated days-of-the-week designs must be cut out with arrow heads at both ends to serve as locks for the lever.
xiii. One end of the arrow points is cut half-way under the arrow head and through that end, the days-of-the-week lever is inserted into the calendar to complete the process of making the calendars
xiv. The complete set of All-time Calendars are set in one of three ways:—
   (a) By reference to a limited 200-year ‘Guide’, (1901-2100). The guide lists 200 years with leap years asterisked. The years have numbers by them designating the day of the week on which the year begins. The guide designates Sun=1, Mon=2, Tue=3, Wed=4, Thu=5, Fri=6, Sat=7. When a particular year begins on a Monday, say, the figure ‘2’ would be shown by the year; place the Monday on the lever to align with 1^{st} January, and the calendar for that year is set.
   (b) Without the guide, the year following a particular year, can be set by shifting the lever just one day ahead, if that particular year is a normal year, and two days ahead, if that year is a leap year. Example, if a year begins on a Sunday, say, shift the lever on Monday, if a normal year, or Tuesday, if a leap year and place it by 1^{st} January, and the following year's calendar is set. By this method, the ‘Guide’ can be expanded either backwards or forwards into infinity!
   (c) If the calendar is not set with the Guide or at the beginning of the year as in (a) and (b) above, the current year calendar can be set on any day of the year. Just confirm the date on which one is setting the calendar; align the day on which one is setting the calendar with the date in the month in which one is setting the calendar, and then the current year calendar is ready.

### Make sure the correct calendar is always used lest the wrong calendar is set for a particular year.

### DRAWING

Refer to 0008 above for description of the various drawings enclosed.

### OATH

An oath attested to by a Notary Public has been enclosed.

### SEQUENCE LISTING

Not Applicable.

1. The All-time Calendar, which I claim as my invention, has the following features which existing calendaring systems do not have:—
i. It is a 2-in-1 set of calendars—one for normal/ordinary years and the other for leap years.
ii. It is easy to use and fast to set—a whole-year calendar is set in just no time.
iii. It uses the same set of calendars for all years, the past, the present, and the future.
iv. The months appear constantly the same on the same page with no changes or adjustments required occasionally.
v. It is compact and therefore saves space in the calendaring process, with no 30^{th} and/or 31^{st} sometimes appearing on the same line as 1^{st} on top of a month
vi. Since the calendar is compact, the individual months must necessarily be displayed in different colours
vii. It sets its own convention—a Sunday can be in the middle of the days of the week column or row for any month.
viii. It makes the twelve months of the year fixed and it is the days of the week that are shifted to match a certain date in a year.
ix. It can be designed in a vertical or horizontal format.
x. It can be designed as Wall, Table/Desk-top, or Pocket-size calendars.
THE PRESENT CALENDARING PROCESS
At present, most calendars are made on a year-to-year basis and are discarded at the end of a year. The permanent calendaring system as used in computers, and other electronic gadgets, and manually operated ones, often display one month at a time; even though computers are able to print whole-year calendars upon request. The present permanent calendaring systems are complex to make and require several rules to learn to manipulate the equipments.
